(19) United States
(12) Patent Application Publication
(10) Pub. No.: US 2008/0170470 A1
(43) Pub. Date: Jul. 17, 2008

(54) EXTENDED-RANGE ULTRASONIC DISTANCE MEASURING APPARATUS AND METHODS OF USING THE SAME

(76) Inventor: Aiwen CHEN, Yancheng (CN)

Correspondence Address: MATTHIAS SCHOLL, 14781 MEMORIAL DRIVE, SUITE 1319, HOUSTON, TX, 77079, US

(21) Appl. No.: 11/972,672

(22) Filed: Jan. 11, 2008

(30) Foreign Application Priority Data
Jan. 15, 2007 (CN) 200710019311.2

(51) Int. Cl. G01S 15/00

(52) U.S. Cl. 367/99

(57) ABSTRACT

This invention provides a method and device to enlarge the scope of ultrasonic measurement. It adopts two-way or more than two-way ultrasonic, and measures the distance in two or more than two directions, especially it can measure the sum distance of two directions directly. Thus the distance value could reach 30 m at one time. Therefore it can enlarge the scope of ultrasonic measuring without changing the performance of ultrasonic transceiver head.

### CROSS-REFERENCE TO RELATED APPLICATIONS

This application claims priority to Chinese Patent Application No. 200710019311.2 filed on Jan. 15, 2007, the contents of which are incorporated herein by reference.

### BACKGROUND OF THE INVENTION

1. Field of the Invention

The present invention relates to a distance-measuring device, more particularly, the invention relates to an ultrasonic distance measuring apparatus.

2. Description of the Related Art

It is a common non-contact distance measurement method to use ultrasonic measuring distance. At present, there are two kinds of ultrasonic measurement methods: The first type adopts echo measurement which receives and sends ultrasonic together. It uses single ultrasonic head to send out ultrasonic wave to the object, then the same ultrasonic head or the other head in the same equipment will receive the signal and finish the distance measurement; The distance measured by this way is limited, generally not beyond 20 m, thus the application is limited; The second type uses fission style equipment, which contains main body and target. Place the target in the right place before measuring. The main body controls the target to send out ultrasonic wave by assistant device (e.g. Infrared transceiver device), and then the main body receives the signal and finishes the distance measurement. Although it could enlarge the scope of measurement, but it is necessary to make two machines, one for emitting and the other for receiving the controlling signal, at the same time it also needs other assistant device to assure that the receiving and emitting are in the same step. Thus the cost is high and it is also not convenient to operate.

### SUMMARY OF THE INVENTION

In order to overcome the technical shortcomings, the invention provides a method which could enlarge the scope of ultrasonic measurement. It apply 2 or more than 2 ultrasonic waves measuring the distance through two or more than two directions, especially it also measures the sum distance of the opposite directions. Thus the measure distance value could reach 30 m in one measure process. Therefore it can enlarge the scope of ultrasonic measurement without changing the performance of ultrasonic device as the ultrasonic transceiver.

The invention also provides a device to practice the said method. The device applies 2 or more than ultrasonic transceiver, with reasonable structure, convenient manufacturing, low cost, large measuring range, convenient operation. And it is convenient to find out the midpoint of the location of the two target objects by dynamic measuring.

Accordingly, the present invention has been made in view of the above problems, and it is an object of the present invention to provide a distance measurement method and device using ultrasonic waves wherein the range of the measure distance can be enlarged in measuring the distance using 2 or more than 2 ultrasonic wave signals.

According to the invention, an ultrasonic distance measure method which could enlarge the range of the measure distance, comprising the steps of: transmitting ultrasonic; receiving the echo signals; processing the echo signals by using a microprocessor; displaying the value of distance; characterized in that: the number of the transmitting ultrasonic is 2 or more than 2; if transmit 2 ultrasonic, they will be transmitted from opposite directions according to an time order; then the microprocessor will processes the echo signals from each ultrasonic within preestablished time; the distance value will be displayed, the value of the sum of the distance of the opposite directions will also be displayed.

Said ultrasonic distance measure device comprises, ultrasonic transceiver, the ultrasonic transmitting and receiving circuits, a display device and a displaying circuit, a function key and its controlling circuit, a power, a microprocessor; said ultrasonic transmitter/receivers connecting the microprocessor through the ultrasonic transmitting and receiving circuits, said display connecting the microprocessor through the displaying circuit said function key and power connecting the microprocessor directly; characterized in that: the number of ultrasonic transmitter/receivers is 2 or more than 2, wherein at least 2 ultrasonic transmitter/receivers are set on the opposite position.

Said ultrasonic distance measure device comprises, the laser emitters, which have the same amounts of said ultrasonic transmitter/receivers, each laser emitter connecting the microprocessor through its own laser-aiming location circuit, in order to indicate the location of every measure ultrasonic.

Said ultrasonic distance measure device comprises, a temperature compensation circuit, which is connected with the microprocessor, the microprocessor could perceive the environment temperature by said temperature compensation circuit, and then compensating the calculated distance according to the different rate of sound waves.

The advantage of the invention lies in that: It measuring the value of the distance of 2 or more than 2 directions, using 2 or more than 2 ultrasonic wave signals at the same time. Especially it also measures the value of the sum distance of the opposite directions. Thus the measure distance value could reach 30 m in one measure process. Therefore it can enlarge the scope of ultrasonic measurement without changing the performance of ultrasonic device as the ultrasonic transceiver.

### BRIEF DESCRIPTION OF THE DRAWINGS

The foregoing Summary as well as the following detailed description will be readily understood in conjunction with the appended drawings which illustrate preferred embodiments of the invention. In the drawings:

FIG. 1 is the structure sketch for example 1;

FIG. 2 is the structure sketch for example 2;

FIG. 3 is the flow chart of the microprocess's main procedure;

FIG. 4 is the flow chart of the microprocess's subprogram.

### DETAILED DESCRIPTION OF THE INVENTION

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

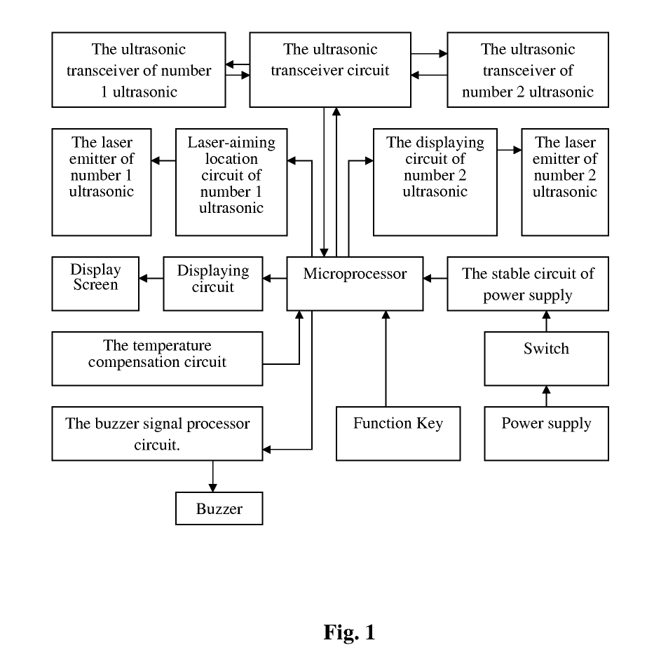

In accordance with the basic layout which can be seen from the FIGS. 1, 2, 3 and 4.

Example 1, as show in FIG. 1, an ultrasonic distance measure device comprises, ultrasonic transceiver, the ultrasonic transmitting and receiving circuits, 2 laser emitters, laser-aiming location circuit, a temperature compensation circuit, a buzzer, buzzer signal processing circuit, a display device, displaying circuit, a function key, a power, and a microprocessor; the 2 ultrasonic transceiver are set on the opposite positions and is connected with the microprocessor through the ultrasonic transmitting and receiving circuits, said 2 laser emitters is connected with the microprocessor their own laser-aiming location circuit, in order to indicate the location of every measure ultrasonic wave, said temperature compensation circuit is connected with the microprocessor, the microprocessor could perceive the environment temperature by said temperature compensation circuit, and then compensating the calculated distance according to the different rate of sound waves; said buzzer is connected with the microprocessor through the buzzer signal processing circuit, which could make the sound of the indication when the microprocessor send the indication signal during the period of the measure distance process. Said display is connected with the microprocessor through the displaying circuit, said function key is connected with the microprocessor; said power is connected with the microprocessor through the power supply stable circuit and switch.

Said device has two measuring patterns: one is to measure the distance using only one transmitter/receiver through one direction; the other is to measure the distance using 2 transceiver through the opposite directions. The two measuring patterns are controlled by the microprocessor, and could be changed by switching the function key.

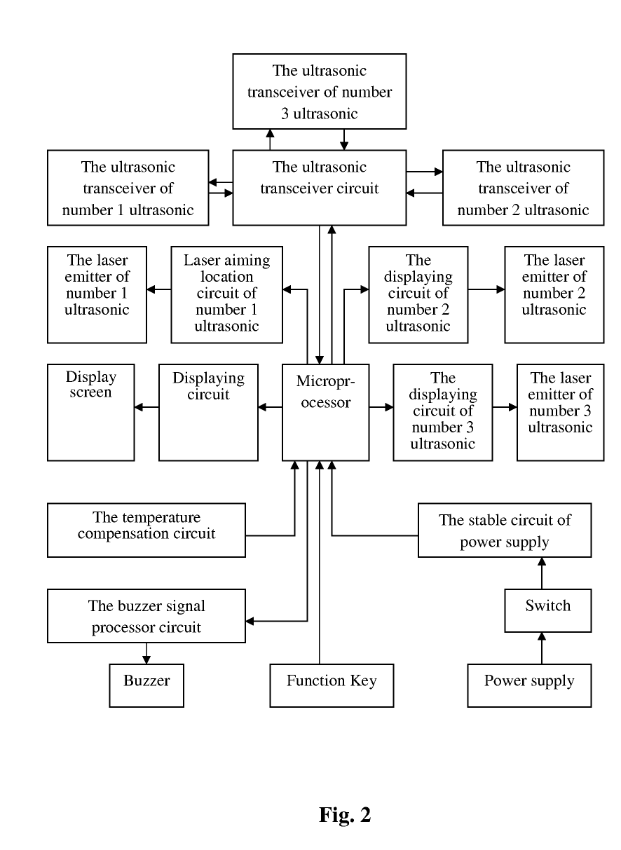

Example 2, as show in FIG. 2, an ultrasonic distance measure device comprises, 3 ultrasonic transceiver, 3 laser emitters. Said 3 ultrasonic transceiver are connected with the microprocessor through the ultrasonic transmitting and receiving circuits; 2 ultrasonic transceiver of the 3 ultrasonic transceiver are set on the opposite positions. Said 3 laser emitters are connected with the microprocessor their own laser-aiming location circuit, in order to indicate the location of every measure ultrasonic wave. The others are the same with the description of example 1.

Said device has 3 measuring patterns compared to example 1, it could measure the distance not only through one direction or two directions, but also could measure the distance through 3 directions at the same time. The 3 measuring patterns are controlled by the microprocessor, and could be changed by switching the function key.

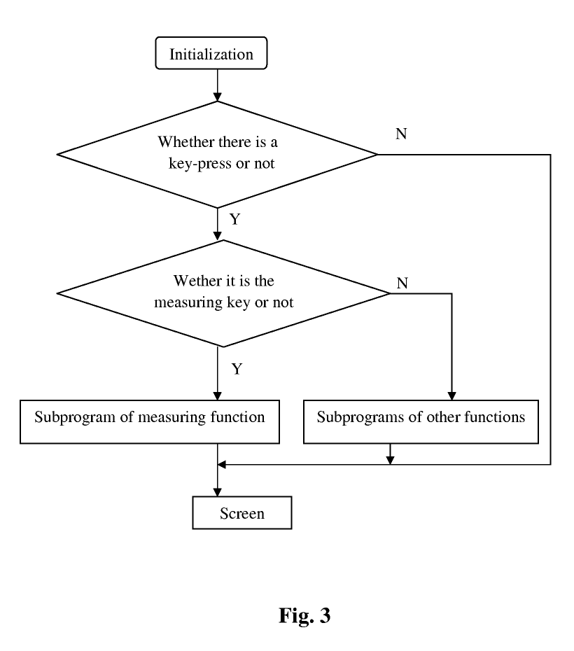

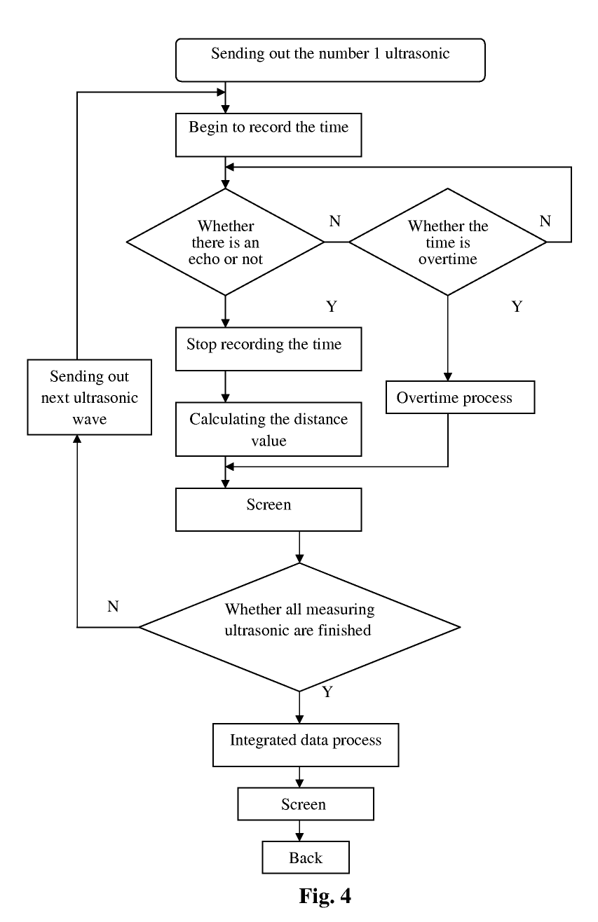

The signal processor of the invention uses microprocessor as its control body. The microprocessor sends out diversified control signals and does recognizing process to every injection signal, as show in FIG. 3. The control part of microprocessor comprise, main program, subprogram for measuring function and other subprograms for other functions. The main program has a circular work pattern controlled by the function key, and it decides to use the measuring function or other functions according to the input of the function key. The result of every subprogram will clearly be displayed on the display screen. The subprogram for measuring function can finish the work of emitting and receiving of every ultrasonic wave, reading of time value, calculating and displaying of the distance value, processing integrated data, exporting and displaying the integrated data and so on. As show in FIG. 4, when the program enters into the subprogram, the microprocessor firstly controls the emitting of the number 1 ultrasonic. Then the time recorder in microprocessor begins to record the time. After receiving the echo signal in desirable time, the time recorder just stops. Then the microprocessor calculates the distance value and displays it on the screen. If the microprocessor does not receiving the echo in desirable time, it will do overtime process and display the result. After finishing the measuring of number 1 ultrasonic, the ultrasonic wave of number 2 ultrasonic will send out, the rest may be deduced by analogy. after measuring of all ultrasonic waves in turn, the microprocessor will do integrate process to measuring data, for example, show the sum value of the distance in opposite directions, confirm the midpoint, calculate the area and volume, and so on.

What is claimed is:

1. An ultrasonic distance measure method which could enlarge the range of the measure distance, comprising the steps of: transmitting ultrasonic; receiving the echo signals; processing the echo signals by using a microprocessor; displaying the value of distance; characterized in that: the number of the transmitting ultrasonic is 2 or more than 2; if transmit 2 ultrasonic, they will be transmitted from opposite directions according to an time order; then the microprocessor will processes the echo signals from each ultrasonic within preestablished time; the distance value will be displayed, the value of the sum of the distance of the opposite directions will also be displayed.

2. An ultrasonic distance measure device as claimed in claim 1, comprises, ultrasonic transceiver, the ultrasonic transmitting and receiving circuits, a display device and displaying circuit, a function key and its controlling circuit, a power, a microprocessor; said ultrasonic transceiver connecting the microprocessor through the ultrasonic transmitting and receiving Circuits, said display connecting the microprocessor through the displaying circuit said function key and power connecting the microprocessor directly; characterized in that: the number of ultrasonic transceiver is 2 or more than 2, wherein at least 2 ultrasonic transceiver are set on the opposite position.

3. An ultrasonic distance measure device as claimed in claim 2, characterized in that: said device comprises, the laser emitters, which have the same amounts of said ultrasonic transmitters/receivers, each laser emitter connecting the microprocessor through its own laser-aiming location circuit, in order to indicate the location of every measure ultrasonic.

4. An ultrasonic distance measure device as claimed in claim 2, characterized in that: Said device comprises, a temperature compensation circuit, which is connected with the microprocessor, the microprocessor could perceive the environment temperature by said temperature compensation circuit, and then compensating the calculated distance according to the different rate of sound waves.

5. An ultrasonic distance measure device as claimed in claim 2, characterized in that: Said device comprises, a buzzer, which is connected with the microprocessor through the buzzer signal processor. Thus, when we are doing the measurement, said microprocessor can send out an indication signal of the distance, and then said buzzer can make a sound of the indication.
